(19) United States
(12) Patent Application Publication
(10) Pub. No.: US 2003/0231695 A1
(43) Pub. Date: Dec. 18, 2003

(54) Electrical plug display arrangement

(76) Inventor: Aik Pin Cheah, Victoria (AU)

Correspondence Address: KLAUBER & JACKSON, 411 HACKENSACK AVENUE, HACKENSACK, NJ, 07601

(21) Appl. No.: 10/171,517

(22) Filed: Jun. 13, 2002

(51) Int. Cl. G01K 1/08; G01K 1/14

(52) U.S. Cl. 374/141

(57) ABSTRACT

A plug arrangement to protect peripheral electronics associated with an electrical device from heat generated by that device.

According to the invention, the peripheral electronics are disposed on the plug connecting the electrical device to a power source.

### TECHNICAL FIELD

This invention relates to electrical devices which include peripheral electronics such as a display unit for indicating one or more parameters of the electrical device.

### BACKGROUND TO THE INVENTION

The use of heating appliances has become widespread throughout the modernized world and it is usual to be able to determine one or more parameters of the electrical device, such as temperature. Traditionally, these heating devices, such as electric heaters for heating the environment and more particularly, electric frying pans for use in the kitchen, include one or more display elements disposed on the electrical device to display parameters such as temperature. Often provided with the display unit is a control unit to control the one or more parameters of the electrical device.

While convenient, this arrangement suffers from a number of drawbacks including the fact that because the area immediately about the electrical appliance becomes heated, the display unit and associated electronics are exposed to this heat and can become damaged.

Furthermore, in devices which cook food, it is common that there is splashing of fats and oils in the vicinity of the device which can both damage and soil the display unit.

In most instances, these electrical devices derive their power from the mains power and are connected thereto via a cord and plug arrangement.

It is an object of the present invention to reduce the risk of damage to peripheral electronics such as a display unit and/or a control unit for an electrical appliance such as a heater or frying pan.

### SUMMARY OF THE INVENTION

According to a first aspect of the present invention, there is provided a power plug for connection to a power source and adapted to receive an electrical conductor to deliver power to an electrical device, wherein said power plug has disposed thereon, peripheral electronics for transmitting signals to or receiving signals from said electrical device.

The peripheral electronics may include a display unit for receiving signals from said electrical device, said signals relating to one or more parameters of said electrical device, and for displaying one or more of those parameters.

The peripheral electronics may also include a control for transmitting signals to said electrical device for controlling one or more parameters of the electrical device. Optionally, the peripheral electronics may include both a display unit and a control unit.

Preferably, the electrical device is an electric frying pan.

According to a second aspect of the present invention, there is provided a temperature probe for measuring the temperature of a heat source, the temperature probe being connected at one end of a power cord for receiving power therefrom, the power cord terminating in a plug for connection to a power source, wherein said plug includes peripheral electronics for transmitting to or receiving signals from said temperature probe.

According to a third aspect of the invention, there is provided a power cord including a plug attached at one end of the power cord for connection to a power source and an electrical connector attached at another end of the power cord for connection to an electrical device, wherein peripheral electronics for transmitting signals to or receiving signals from said electrical device are disposed away from said electrical connector and supported either by said power cord or by said plug.

Preferably, the peripheral electronics will be disposed on said plug.

Preferably, said electrical device is an electric frying pan.

According to a fourth aspect of the present invention, there is provided a method of reducing exposure of peripheral electronics for transmitting signals to or receiving signals from an electrical device, to potential damaging heat generated by said electrical device, the electrical device being connected to a power source via a power cord and plug, the method including disposing said peripheral electronics away from said electrical device either on said cord or on said plug.

Preferably, the peripheral electronics will be disposed on said plug.

Preferably, said electrical device is an electric frying pan.

### BRIEF DESCRIPTION OF THE DRAWINGS

A preferred embodiment of the present invention will now be described with reference to the following drawings in which:

FIGS. 1a to d show a power plug according to a first aspect of the present invention;

FIG. 2 shows a temperature probe according to a second aspect of the present invention;

FIG. 3 shows a power cord according to the first aspect of the present invention;

FIG. 4 shows the power cord of FIG. 3 in use; and

FIG. 5 illustrates an alternative embodiment of the present invention.

### DETAILED DESCRIPTION OF THE PREFERRED EMBODIMENT

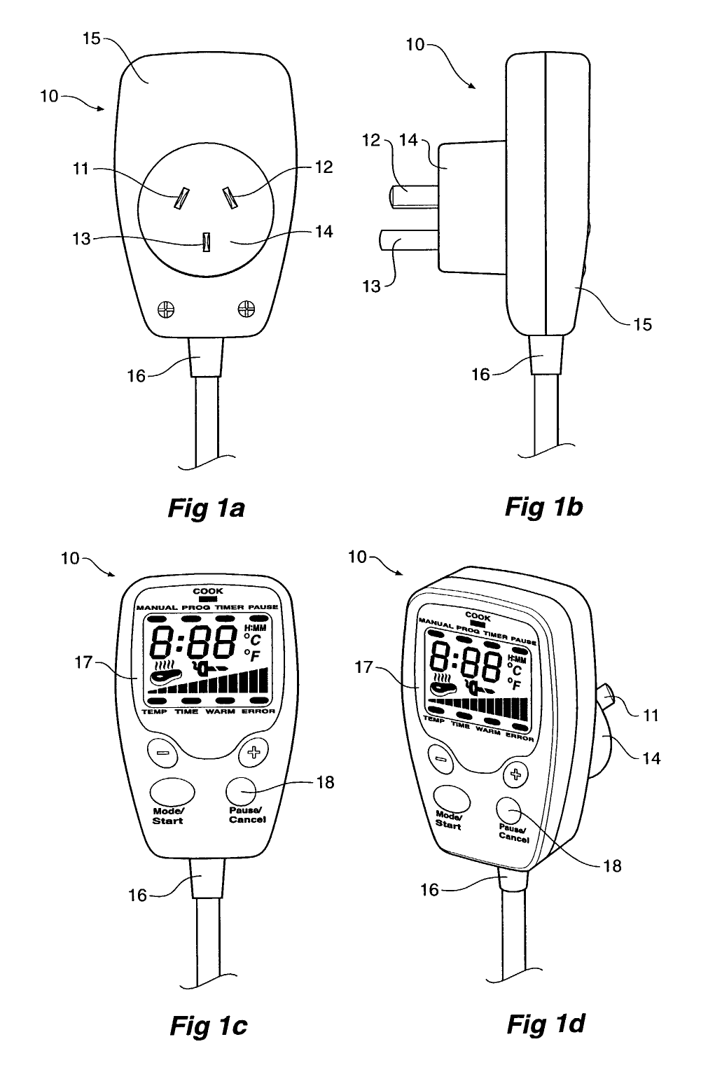

FIGS. 1a to d show a perspective view, rear view, side view and front view respectively of a plug 10 according to a preferred embodiment of the present invention. Plug 10 includes pins 11, 12 and 13 for insertion into a power socket (not shown) as is standard in many countries including Australia. Of course, it will be understood that the configuration of pins may vary depending upon the configuration of the power sockets in a given country. Pins 11 to 13 are supported in pin support 14 connected to plug head 15. Power cord connector 16 is disposed on plug head 15 to receive a power cord (not shown) to transfer electrical power from the power source to an electrical device connected to the other end of the power cord.

As can be seen clearly in FIG. 1d, there is disposed on plug 10 peripheral electronics in the form of a display unit 17 and one or more control units 18. Display unit 17 will display one or more parameters such as temperature relating to an electrical device connected at the other end of the power cord connected to power cord connector 16. Similarly, control unit 18 can transmit signals to the electrical device connected at the other end of the power cord to control one or more parameters of the electrical device.

Signals may be transmitted and received between the peripheral electronics on plug head 15 and the electrical device via one or more conductive paths which in a preferred embodiment, would be embedded within the electrical power cord, as would be understood by the person skilled in the art. However, the signals could conceivably be transmitted and received via radio frequency means or other wireless means as would be understood by the person skilled in the art.

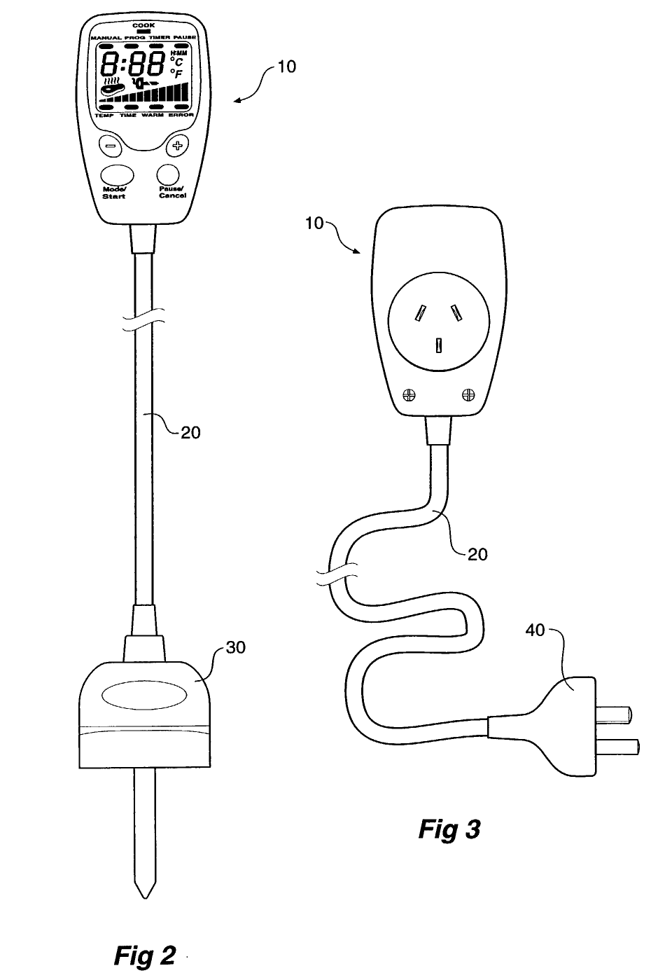

A preferred application of the plug of FIGS. 1a to d is shown in FIG. 2, where there is shown plug 10 connected to an electrical device 30 via power cord 20. In this application, electrical device 30 is a temperature probe which is used to determine the temperature of an additional electrical device (not shown) such as a frying pan or other heat generating device. To sense a temperature, probe 30 must be brought within close proximity to the heat generating device and may be exposed to significant temperatures. Such exposure could damage any peripheral electronics located on the probe and thus according to the invention, peripheral electronics constituting a display unit and/or control units, are distanced from the probe and disposed on the plug.

In FIG. 3, a different embodiment of the invention is shown where temperature probe 30 is replaced by an electrical connector 40 for connection to another electrical device such as a frying pan. Connector 40 is a standard electrical connector which plugs into electrical devices such as frying pans as is commonly done. However, connector 40 may be modified to allow the transfer of control and display signals between plug 10 and the electrical device.

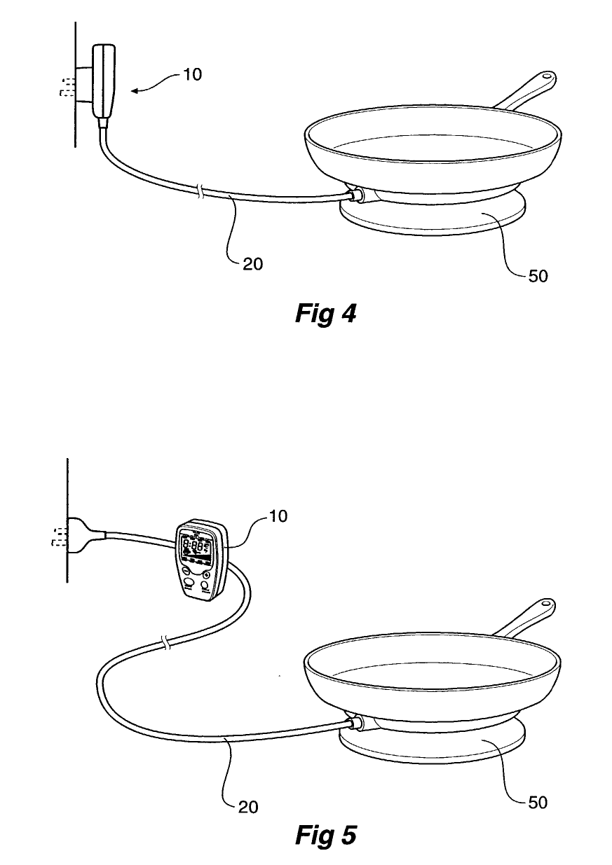

In FIG. 4, the application of the device of FIG. 3 is shown in relation to an electric frying pan 50. In this case, as well as generating significant heat in the region about frying pan 50, splashing of oil and other hot substances commonly occurs, which may also damage any peripheral electronics. With the peripheral electronics located on plug 10, and away from pan 50, the risk of damage of the peripheral electronics is greatly reduced.

Of course it is within the scope of the present invention to have the peripheral electronics as a separate stand alone unit which is able to be kept remote from the electrical device and need not necessarily be disposed on the plug. The peripheral electronics could be disposed on a separate unit which may be separately connected to the electrical device via an additional cord or via wireless means and simply disposed and used away from the electrical device. However, it is preferred that the peripheral electronics are disposed on the plug as this provides a convenient means of supporting the peripheral electronics while at the same time minimising the number of components required. Furthermore, the power cord 20 which is traditionally used to connect plug 10 to the electrical device may be used as a convenient means of transmitting signals between the two elements.

In FIG. 5, a further alternative embodiment is shown where the peripheral electronics 17, 18 are encased in a separate unit 19 which is disposed along the length of cord 20. Cord 20 can be manufactured with unit 19 or unit 19 may be retrofitted to cord 20 by either inserting a signal path within cord 20 or providing a separate signal path outside or cord 20 or of course, simply relying on wireless technology.

The above has been described in the context of a preferred embodiment and variations thereto, however it will be understood by the person skilled in the art that many other variations and modifications are possible within the scope of the present invention. For example, the peripheral electronics need not be limited to display or control elements, but could encompass any suitable electronics that is required to be protected from damage. For example, the peripheral electronics could include a scanner/barcode reader to allow recipes or programs to be scanned in. The program may contain time and temperature settings as well as feedback prompts. The programs could be obtained from a participating website or in recipes found in cook books having a barcode system similar to the G-code for programming video recorders.

The claims defining the invention are as follows:

1. A power plug for connection to a power source and adapted to receive an electrical conductor to deliver power to an electrical device, wherein said power plug has disposed thereon, peripheral electronics for transmitting signals to or receiving signals from, said electrical device.

2. A power plug according to claim 1 wherein said peripheral electronics includes a display unit for receiving signals from said electrical device relating to one or more parameters of said electrical device and for displaying said one or more parameters.

3. A power plug according to claim 1 wherein said peripheral electronics includes a control unit for transmitting signals to said electrical device for controlling one or more parameters of said electrical device.

4. A power plug according to claim 1 wherein said peripheral electronics includes both a display unit and a control unit.

5. A temperature probe for measuring the temperature of a heat source, the temperature probe being connected at one end of a power cord for receiving power therefrom, the power cord terminating in a plug for connection to a power source, wherein said plug includes peripheral electronics for transmitting to or receiving signals from, said temperature probe.

6. A temperature probe according to claim 5 wherein said peripheral electronics includes a display unit for receiving signals from said temperature probe relating to one or more parameters of said temperature probe and for displaying said one or more parameters.

7. A temperature probe according to claim 5 wherein said peripheral electronics includes a control unit for transmitting signals to said temperature probe for controlling one or more parameters of said temperature probe.

8. A temperature probe according to claim 5 wherein said peripheral electronics includes both a display unit and a control unit.

9. A temperature probe according to claim 6 wherein said one or more parameters includes temperature.

10. A power cord including a plug attached at one end of said cord for connection to a power source and an electrical connector attached at another end of said cord for connection to an electrical device, wherein peripheral electronics for transmitting to or receiving signals from said electrical device are disposed away from said electrical connector and supported either by said cord or by said plug.

11. A power cord according to claim 10 wherein said peripheral electronics are supported by said plug.

12. A power cord according to claim 10 wherein said peripheral electronics includes a display for receiving signals from said electrical device relating to one or more parameters of said electrical device and for displaying said one or more parameters.

13. A power cord according to claim 10 wherein said peripheral electronics includes a control unit for transmitting signals to said electrical device for controlling one or more parameters of said electrical device.

14. A power cord according to claim 12 wherein said one or more parameters includes temperature.

15. A method of reducing exposure of peripheral electronics associated with an electrical device to potentially damaging heat generating by or about said electrical device, said method including disposing said peripheral electronics away from said electrical device.

16. A method according to claim 15 wherein said electrical device is connected to a power source via a power cord and plug and wherein said peripheral electronics are disposed away from said electrical device either on said power cord or on said plug.

17. A method according to any one of claims 15 or 16 wherein said peripheral electronics includes a display unit for displaying one or more parameters of said electrical device.

18. A method according to any one of claims 15 to 16 wherein said peripheral electronics includes a control unit for controlling one or more parameters of said electrical device.

19. A method according to claim 16 wherein said peripheral electronics includes both a display unit and a control unit.

20. A method according to claim 16 wherein said peripheral electronics is disposed on said plug.
